(19) United States
(12) Patent Application Publication
(10) Pub. No.: US 2004/0245063 A1
(43) Pub. Date: Dec. 9, 2004

(54) Pressure plate assembly for a friction clutch

(76) Inventors: Sebastian Vogt, Bad Neustadt (DE); Andreas Orlamunder, Schweinfurt (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/491,199

(22) PCT Filed: Sep. 27, 2002
(86) PCT No.: PCT/EP02/10877

(30) Foreign Application Priority Data
Sep. 28, 2001 (DE) 101 48 176.4
Jul. 30, 2002 (DE) 102 34 548.1
Aug. 28, 2002 (EP) 02019060.9
Sep. 23, 2002 (DE) 102 44 211.8

(51) Int. Cl. F16D 13/75

(52) U.S. Cl. 192/70.25; 192/111 A

(57) ABSTRACT

A pressure plate assembly for a friction clutch comprises a housing arrangement, a pressure plate connected to the housing arrangement for rotation about an axis (A), a force-exerting arrangement, which is or may be supported relative to the pressure plate and the housing arrangement, and a wear take-up arrangement in the support path between the force-exerting arrangement and the housing arrangement. The wear take-up arrangement includes at least one adjusting element which may be displaced to compensate for wear, by means of which the force-exerting arrangement is or may be supported relative to the housing arrangement, a wear detection arrangement, mounted on the housing arrangement, which co-operates with the force-exerting arrangement in a wear detection area and which may shift, in the case of wear, relative to the housing arrangement, by means of the force-exerting arrangement. The wear detection arrangement has a take-up distance limiting area which co-operates with the at least one adjustable element to limit the take-up distance and further has at least one blocking element, which stops the return movement of the wear detection arrangement after the shift relative to the housing arrangement, as a result of wear-induced displacement of the wear detection arrangement.

### TECHNICAL AREA

The present invention pertains to a pressure plate assembly for a friction clutch, comprising a housing arrangement; a pressure plate, which can be connected to the housing arrangement for rotation in common around an axis of rotation; a force-exerting arrangement, which is supported against the pressure plate and the housing arrangement; and a wear take-up device for compensating for the wear which occurs during the operation of the friction clutch.

### STATE OF THE ART

To ensure that the various system areas of a friction clutch or the various system areas assigned to a friction clutch can retain essentially the same operating characteristics even after the occurrence of wear, such as wear to the friction linings of a clutch disk, it is known that the wear occurring in a clutch can be compensated automatically. It is known in particular that wear-compensating devices can be installed in the path of support between a force-exerting arrangement, such as, for example, a diaphragm spring or a force-transmitting lever arrangement, and the pressure plate.

### TASK OF THE INVENTION

The task of the present invention is to provide a pressure plate assembly with automatic wear compensation, in which, although the system components serving to compensate for the wear are of simple design, the wear can nevertheless be compensated in a reliable and essentially error-free manner.

### DESCRIPTION OF THE INVENTION

This task is accomplished according to the invention by a pressure plate assembly for a friction clutch, comprising a housing arrangement; a pressure plate, which is connected to the housing arrangement for rotation in common around an axis of rotation; a force-exerting arrangement, which is or can be supported against the pressure plate and the housing arrangement; and a wear take-up device in the path of support between the force-exerting arrangement and the housing arrangement, where the wear take-up device comprises at least one adjusting element, which can shift position to compensate for wear and by which the force-exerting arrangement is or can be supported against the housing arrangement; a wear detection arrangement, which is supported on the housing arrangement and cooperates with the force-exerting arrangement in a wear detection area; which, upon the occurrence of wear, can be shifted relative to the housing arrangement by the force-exerting arrangement; and which cooperates with the minimum of one adjusting element in a take-up distance-limiting area to limit the take-up distance; and at least one blocking element, which, after the wear-induced shift of the wear detection arrangement relative to the housing arrangement, prevents the wear detection arrangement from reversing its movement.

In the pressure plate assembly according to the invention, the arrangement serving to compensate for wear performs its function between a housing and the force-exerting arrangement, so that no special measures need to be taken in the support area between the force-exerting arrangement and the pressure plate; in particular, the pressure plate does not have to be fabricated in any special way. When clutch-engaging and disengaging operations are carried out, only the pressure plate must be moved, not any additional assemblies provided on it for wear take-up. This makes it possible to obtain improved clutch operating behavior. Because, according to the invention, at least one blocking element is assigned to the wear take-up device acting between the force-exerting arrangement and the housing arrangement, it is ensured, first, that any wear-induced movements which may have occurred cannot be reversed under the influence of, for example, the forces being exerted by the force-exerting arrangement or under the influence of the vibrations or oscillations normally present in a system of this type.

For example, in a pressure plate assembly according to the invention, it is possible, after wear has occurred, for the wear detection arrangement to be actuated by an area of the force-exerting arrangement which moves away from the housing arrangement.

So that in can be ensured that the minimum of one blocking element assigned to the wear detection arrangement reliably prevents reverse movement, regardless of the position to which the wear detection arrangement has moved, it is proposed that the minimum of one blocking element comprise a wedge-like blocking slide, which is pretensioned into an intermediate space formed between the housing arrangement and the wear detection arrangement. It is possible for the blocking element to be pretensioned between the housing arrangement and a section of the wear detection arrangement that cooperates with the minimum of one adjusting element.

In an arrangement which is very simple in design but which nevertheless operates very reliably, the minimum of one adjusting element can comprise an adjusting ring.

To avoid undesirable shifts of the wear detection arrangement with respect to the housing arrangement, it is proposed that the wear detection arrangement be supported nonpositively on the housing arrangement. This nonpositive connection can also be reinforced by a set of very small teeth.

The present invention also pertains to a friction clutch with a pressure plate assembly according to the invention in which the friction clutch can be designed as a dual clutch. These types of dual clutches therefore have two clutch areas. According to the principles of the present invention, a wear take-up device designed according to the invention with the various components assigned to it can thus be provided in at least one of the two clutch areas.

The present invention is described in greater detail below with reference to the attached drawings:

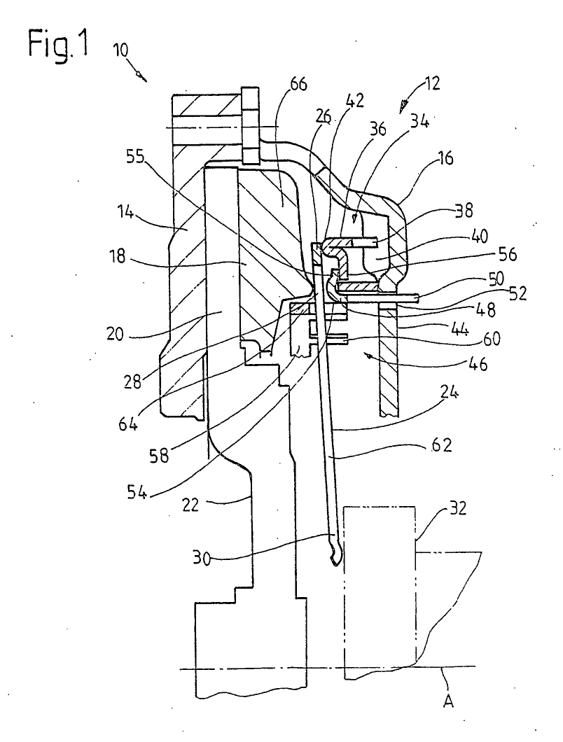

FIG. 1 shows a longitudinal cross section through a friction clutch with a wear take-up device designed according to the invention;

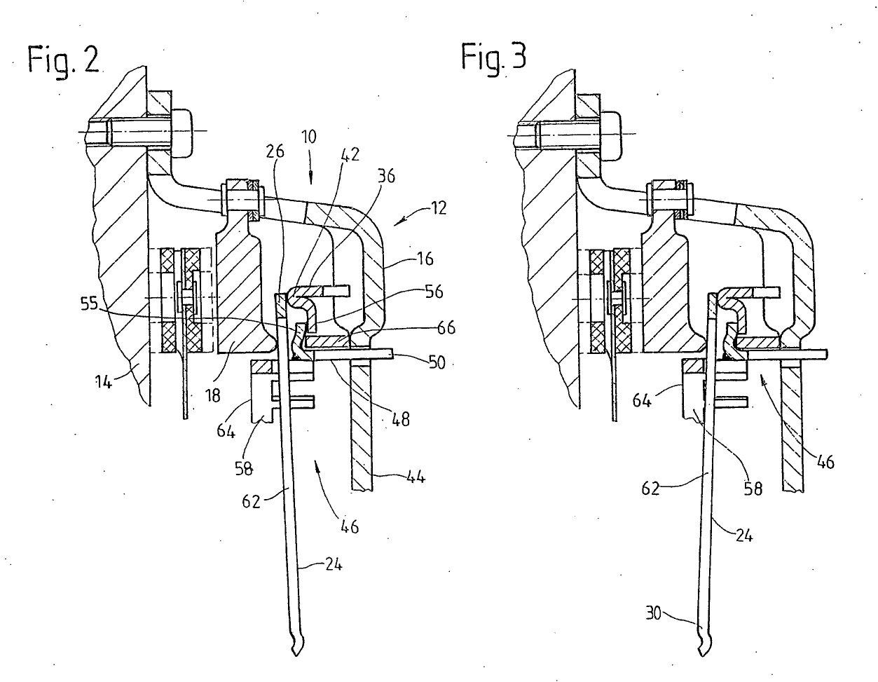

FIG. 2 shows the essential system components of the friction clutch shown in FIG. 1 in the disengaged state of the clutch before any wear has occurred;

FIG. 3 shows a view of the friction clutch according to FIG. 3 in the engaged state;

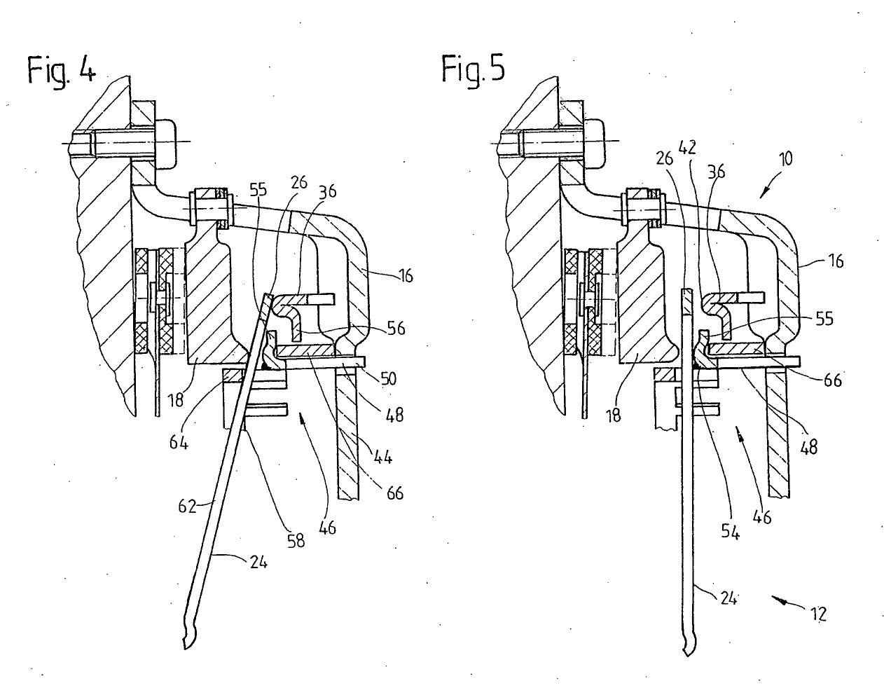

FIG. 4 shows the friction clutch in the engaged state after wear has occurred;

FIG. 5 shows the friction clutch in the disengaged state or in the transition phase to a disengaged state after wear has occurred;

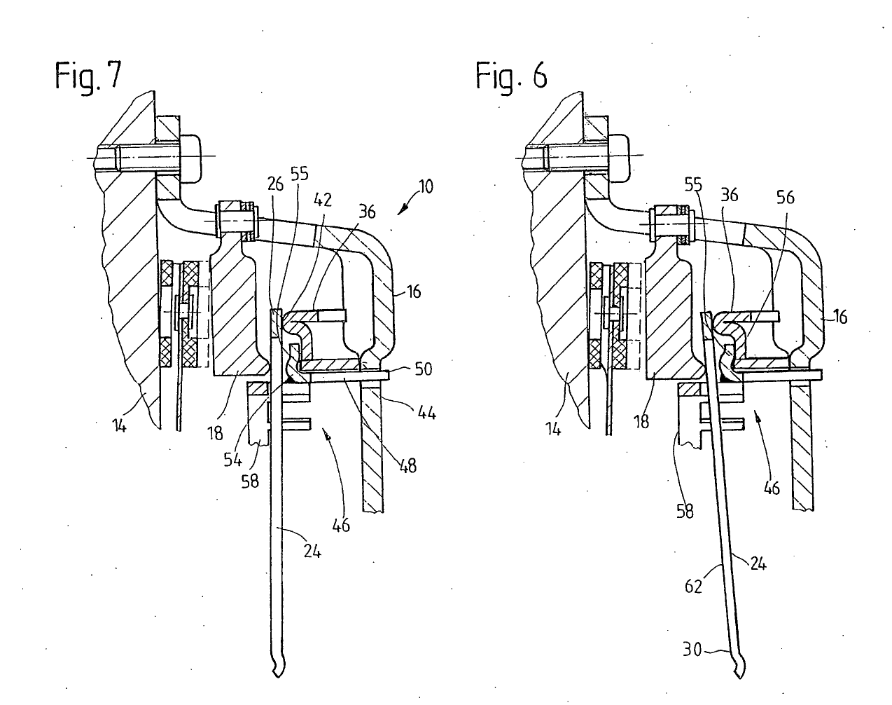

FIG. 6 shows the friction clutch in the disengaged state after a wear take-up operation has occurred;

FIG. 7 shows the friction clutch in the engaged state after a wear take-up operation has occurred;

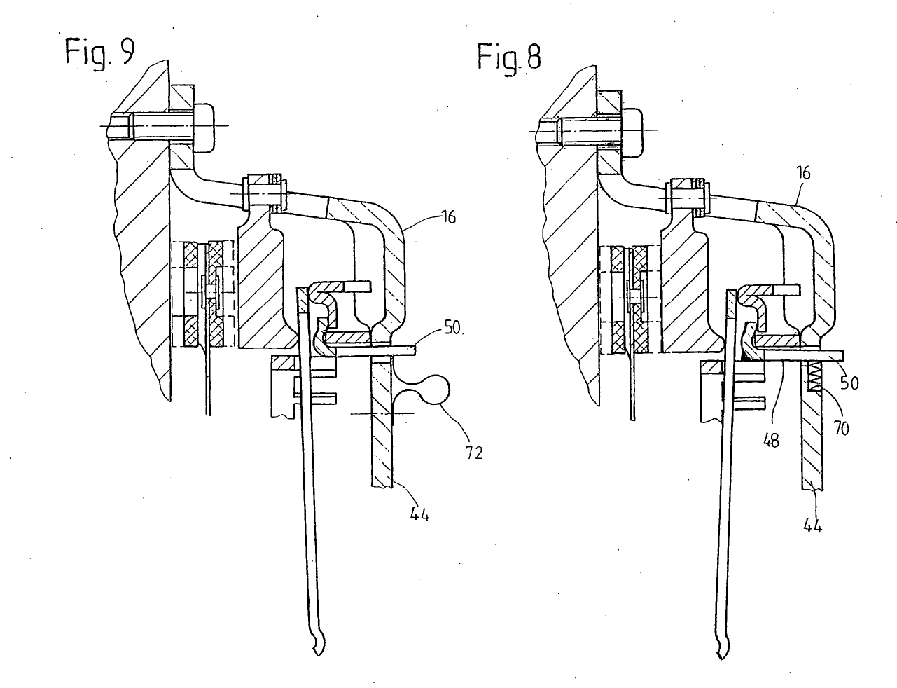

FIG. 8 shows a variant of the design of the pressure plate assembly according to the invention;

FIG. 9 shows another modified variant of the design of the pressure plate assembly according to the invention; and

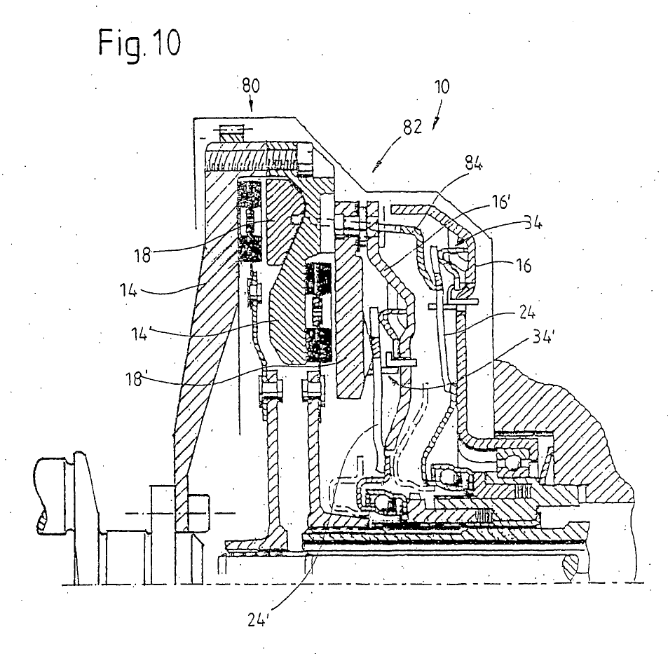

FIG. 10 shows a dual clutch with pressure plate assemblies according to the invention, i.e., with wear take-up devices designed in accordance with the invention.

First, the design of a friction clutch 10, i.e., of a pressure plate 12 according to the invention forming part of this friction clutch 10, is described in general terms with reference to FIG. 1. The friction clutch 10 comprises a flywheel 14, such as a dual-mass flywheel or the like, which can be connected to a drive shaft, such as the crankshaft of a drive unit, for rotation in common around an axis of rotation A. Radially on the outside, the housing 16 of the pressure plate assembly 12 is or can be connected nonrotatably to the flywheel 14. In the housing 16, a pressure plate 18 is provided, which is connected essentially nonrotatably by tangential leaf springs or other connecting elements to the housing 16 but is still free to move to a certain extent in the direction parallel to the axis of rotation A. The pressure plate 18 can be also connected to the housing 16 by connecting devices that reinforce the pressing force. The friction linings 20 of a clutch disk, designated 22 overall, lie between the pressure plate 18 and the flywheel 14. A force-exerting arrangement 24, supported in its radially outer area 26 against the housing 16 by measures to be described in greater detail below, has an area 28 located somewhat farther inward in the radial direction, which actuates the pressure plate 18 by exerting force on a blade-like area, for example, of the plate; the radially innermost end 30 of the force-exerting arrangement is actuated by an actuating mechanism 32. In the example shown here, the force-exerting arrangement 24 comprises an engaging force-transmitting lever arrangement, which itself contributes no force of its own. The radially inner area of the lever arrangement, that is, the radially inner end 30, however, can be pressed by the actuating mechanism 32 toward the flywheel 14 to transmit the engaging force to the pressure plate 18. It is obvious that the force-exerting arrangement 24 can comprise, for example, an energy storage device such as in particular a diaphragm spring, which, in the arrangement shown in FIG. 1, operates as part of a clutch of the so-called “pulled” type.

So that the wear that occurs in the area of the friction linings 20 of the friction clutch 10 can be compensated, a wear take-up device designated 34 overall is provided. This comprises an adjusting ring 36. On the side facing the housing 16, the adjusting ring 36 has several ramp surfaces 38, which follow each other in a row around the circumference and which rest against complementary ramp surfaces on the housing 40. A rotation of the adjusting ring 36 around the axis of rotation A has the effect that a support area 42 of the ring, by which the force-exerting arrangement 24 is supported against the housing 16, shifts in the axial direction, namely, in the direction away from the bottom area 44 of the housing 16 and toward the flywheel 14. To induce this displacement, a pretensioning spring can be provided, by means of which the adjusting ring 36 is pretensioned to turn in the circumferential direction relative to the housing 16. During this rotational movement, therefore, the adjusting ring 36 simultaneously shifts in the axial direction. It should be pointed out here that two adjusting rings, for example, each with complementary ramp surfaces resting against each other, could also be provided. In this case, the adjusting ring 36 shown would again form the support area 42 for the force-exerting arrangement 24, but would be held nonrotatably relative to the force-exerting arrangement 24. The second adjusting ring, supported on the housing 16, would then be pretensioned by the previously mentioned pretensioning force to rotate in the circumferential direction. The turning of this second ring in the circumferential direction around the axis of rotation A would then again have the effect of shifting the axial position of the adjusting ring 36 shown.

The wear take-up device 34 also comprises a wear detection arrangement, designated 46 overall. The wear detection arrangement 46, in the example shown here, has a first, basically ring-like component 48 with several axially oriented connecting projections 50, which pass through associated openings 52 in the bottom area 44 of the housing 16. A ring-like section 54 has radially outward-extending projections 55, which overlap a corresponding section 56 of the adjusting ring 36 to form a take-up distance-limiting area for the adjusting ring 36, the function of which will be described more fully below. If the projections 50, which extend essentially in the axial direction through the openings 52, are pretensioned in the radially outward direction, they will then rest in a friction-locking manner against the bottom area 44 of the housing 16 and ensure that, in general, the component 48 will not be able to shift independently with respect to the housing 16.

A second essentially ring-like component 58 has again several axial projections 60, which pass between individual lever sections 62 of the force-exerting arrangement 24 and are connected to the first-mentioned component 48 by welds, for example. The lever sections 62 of the force-exerting arrangement 24 are therefore situated axially between the ring-like section 54 of the component 48 and a ring-like section 64 of the component 58. The lever sections are not permanently clamped axially in place here; instead, as can be seen in FIG. 1, the areas of the individual lever sections 62 which pass essentially in the radial direction through the wear detection arrangement 46 have a certain amount of axial play.

The wear detection arrangement 46 also has at least one blocking element 66. This blocking element 66 is designed in the form of a wedge and forms a slide, which can move in the circumferential direction and engage the intermediate space formed between the bottom area 44 of the housing 16 and the radially outward-extending sections 55 of the component 48, which sections are a certain distance apart in the circumferential direction; this slide is also pretensioned into this intermediate space by a pretensioning spring. For the sake of symmetry, it is advantageous to provide several blocking elements 66, distributed around the circumference.

The function of the wear take-up device 34 described on the basis of FIG. 1 will now be described in detail below on the basis of FIGS. 2-7. Only the components essential for this purpose are discussed.

FIG. 2 shows the pressure plate assembly 12, i.e., the friction clutch 10 containing this assembly, in a state in which no wear has yet occurred, such as when the clutch is new. The friction clutch 10 is disengaged here. This means that the force-exerting arrangement 24 is not exerting any force which could have the effect of pretensioning the pressure plate 18 toward the flywheel 14; thus, in a corresponding manner, the radially outer area 26 of the force-exerting arrangement 24 is also exerting essentially no force on the support area 42 of the adjusting ring 36. As a result of the previously mentioned pretensioning effect, the adjusting ring 36 would have the tendency in and of itself to rotate in the circumferential direction, which would also lead to an axial displacement. The adjusting ring 36 is nevertheless prevented from moving axially and thus also prevented from rotating by the wear detection arrangement 46, specifically by the sections 55 of this arrangement, which extend radially over the area 56 of the adjusting ring 36; the wear detection arrangement is also being held nonpositively on the housing 16 by the pretensioning effect of the axial projections 50. In addition, the minimum of one blocking element 66, among other things, prevents the component 48 and thus the entire wear detection arrangement 46 from shifting toward the bottom area 44 of the housing 16. It can be seen that there is a small intermediate axial space between the lever sections 62 of the force-exerting arrangement 24 and the ring-like area 64 of the second component 58 of the wear detection arrangement 46, so that, even during the transition to the engaged state shown in FIG. 3, during which the radially inner ends 30 of the force-exerting arrangement 24 are shifted toward the flywheel, the lever sections 62 do not make contact with the ring-like area 64 or do not make contact with it to such an extent that the second component 58 and thus the entire wear detection arrangement 46 could be carried along in the axial direction.

When wear now occurs during the performance of clutch-engaging operations, the result, as illustrated in exaggerated manner in FIG. 4, is that the lever sections 60 of the force-exerting arrangement 24 pivot much farther, so far, in fact, that the areas of these lever sections 62 located radially inside the point where the pressure plate is actuated, move a comparatively long distance away from the bottom area 44 of the housing 16. As this happens, the lever sections 62 of the force-exerting arrangement 24 now come to rest against the ring-like area 64 of the component 58 and carry the entire wear detection arrangement 46 along with them in the axial direction in opposition to the friction-locking effect of the projections 50 on the housing 16. The sections 55 are now lifted away from the area 56 of the adjusting ring 36. The ring, however, still cannot rotate, because in this state it is still under the powerful force being exerted by the radially outer area 26 of the force-exerting arrangement 24.

When the wear detection arrangement 46 shifts axially, the axial intermediate space between the radially outward-extending sections 55 of the component 48 and the bottom area 44 of the housing 16 becomes larger. The wedge-like blocking element 66, which is under the pretensioning force of an assigned spring, now moves into this enlarged intermediate space, which reliably ensures that the wear detection arrangement 46 can no longer move in reverse after it has shifted its axial position relative to the housing 16 in correspondence with the wear which has occurred.

If then the friction clutch 10 is returned to the disengaged state, shown in FIG. 5, the radially outer area 26 of the force-exerting arrangement 24 stops exerting force on the adjusting ring 36. Because, in this condition, the ring is no longer being prevented from moving axially by the sections 55 of the wear detection arrangement 46 either, it will respond to the pretensioning effect of a pretensioning spring or the like and thus rotate in the circumferential direction, this being accompanied by a shift in the axial direction relative to the housing 16. This rotational/shifting movement will then in fact take place as the force-exerting arrangement 24 pivots; the state shown in FIG. 5, in which an intermediate space is present between the radially outer area 26 of the force-exerting arrangement 24 and the support area 42 of the adjusting ring 36, is illustrated only to clarify the relevant functional principles. The adjusting ring 36 will actually always follow the movement of the radially outer area 26 of the force-exerting arrangement 24.

During the transition to the disengaged state, it is possible for the force-exerting arrangement 24 to arrive in contact with the ring-like area 54 of the component 48. Because this component is prevented from moving in reverse by the blocking element 66, however, there is no danger that the component 46 could move in reverse unintentionally, and thus there is no danger that the entire wear detection arrangement 46 could move in reverse.

The adjusting ring 36 will continue to turn until its area 56 comes to rest again against the sections 55 of the wear detection arrangement 46. A normal disengaged state is then present again, as shown in FIG. 6, in which the force-exerting arrangement 24 is basically resting again on the pressure plate 18 and on the adjusting ring 36, but is not exerting any significant amount of force on them. In this state, however, the axial position of the force-exerting arrangement 24 in the housing 16 has changed in correspondence with the amount of wear which has previously occurred. It can be seen that the force-exerting arrangement 24 is now somewhat closer to the flywheel 14. Because the radially inner end 30 of the force-exerting arrangement 24 has also shifted axially to a similar extent, it can be advantageous to perform a corresponding compensation in the actuator mechanism 32.

Starting from the state shown in FIG. 6, in which previous wear has already been compensated, the friction clutch 10 can now be engaged again and will thus arrive in the engaged state shown in FIG. 7, in which the radially outer area 26 of the force-exerting arrangement 24 is again supported on the support area 42 of the adjusting ring 36, while the force-exerting arrangement 24 presses the pressure plate 18 toward the flywheel 14.

As previously mentioned, the axial projections 50 of the component 48 of the wear detection arrangement 46 rest under radial pretension against the bottom area 44 of the housing 16. This pretension can be provided by giving the component 48 an appropriate shape and by taking advantage of the intrinsic elasticity of the projections 50.

In the case of the variant shown in FIG. 8, a pretensioning spring 70, designed as a helical compression spring, can also be provided, if desired, to reinforce the intrinsic elasticity of the projections 50; such a spring can be assigned to each or at least to some of the projections 50. The springs will be oriented in a more-or-less radial direction and will be supported at one end on the projections 50 and at the other end on the bottom area 44 of the housing 16. In this way, it is possible to ensure a sufficiently strong pretensioning effect and thus a sufficiently strong nonpositive connection, regardless of the materials which have been selected and thus regardless of the strength of the component 48.

In the case of the design variant shown in FIG. 9, this pretensioning effect, provided for at least some of the projections 50, can be accomplished by means of a spring element 72, designed in the manner of, for example, a leaf spring, one leg of which is attached to the bottom area 44 of the housing 16, while the other leg exerts force on its assigned projection 50. It is obvious that, both in the design variants shown in FIGS. 1-7 and in the design variants shown in FIGS. 8 and 9, the frictional effect could also be accomplished by pretensioning the projections 50 radially toward the inside. A pretensioning effect acting in the circumferential direction on the associated sections of the housing is also possible, especially if additional springs, etc., are used as pretensioning elements.

A wear take-up device 34 designed according to the invention has been presented above in conjunction with a conventional motor vehicle clutch, i.e., a so-called simple clutch. FIG. 9 shows a friction clutch 10 designed as a dual clutch, in which the principles of the present invention are also realized. This friction clutch 10 comprises two clutch areas 80, 82, each with is own pressure plate 18, 18′ and an assigned abutment arrangement or flywheel 14, 14′. The two flywheels 14, 14′ are connected permanently to each other in their radially outer areas. In addition, each of the clutch areas 80, 82 has its own housing 16, 16′. These two housings 16, 16′ are permanently connected to each other in their radially outer areas, for example, and also to the flywheel 14′. A force-exerting arrangement 24 of the first clutch area 80 is supported by way of a wear take-up device 34, as previously described, against the assigned housing 16 and is supported against the pressure plate 18 by way of a force-transmitting element 84. The force-exerting arrangement 24′ of the second clutch area 82 is supported against the housing 16′ by way of an assigned wear take-up device 34′, and, as previously described, actuates the assigned pressure plate 18′ directly.

In an arrangement of this type, that is, in an arrangement in which the two pressure plates 18, 18′ of a dual clutch are moved in the same axial direction to perform their clutch-engaging operations, wear take-up devices 34, 34′ according to the invention can also be used to compensate for the wear which occurs in the area of the assigned clutch disks.

Although obvious in itself, it should be pointed out that many different modifications can be made to the design in the area of the dual clutch or of the associated clutch areas 80, 82. For example, the two pressure plates 18, 18′ can be positioned so that they must be moved in opposite axial directions to execute their clutch-engaging operations. In the example shown in FIG. 10, therefore, the flywheel 14′ forms the abutment for both clutch areas 80, 82, and the pressure plate 18 of the first clutch area 80 would be located on the other axial side of the associated clutch disk. The force-exerting arrangement 24 of this first clutch area 80 would then be supported against the outside surface of the housing 16′ of the second clutch area 82, possibly by way of the assigned wear take-up device 34, and its radially outer area would actuate a force-transmitting element, which would exert a pulling type of force and thus transmit the clutch-engaging force to the pressure plate 18. It is also obvious that, in a dual clutch of this type, it is not necessary for both clutch areas to be provided with a wear take-up device.

1-8. (cancelled)

9. A pressure plate assembly for a friction clutch, the assembly comprising:
a housing;
a pressure plate assembly connected to the housing for rotation in common about an axis of rotation;
a force exerting arrangement supported against the pressure plate and, via a path of support, against the housing;
a wear take-up arrangement in the path of support between the force exerting arrangement and the housing, the wear take-up arrangement comprising:
at least one adjusting element which shift by a take-up distance to compensate for wear and which supports the force exerting arrangement against the housing;
a wear detection arrangement carried on the housing and having a wear detection area which cooperates with said force exerting arrangement to shift said wear detection arrangement relative to said housing in the event of wear of said friction clutch, and further having a take-up distance limiting area which cooperates with said at least one adjusting element to limit the take-up distance; and
at least one blocking element which prevents the wear detection arrangement from reversing its movement after the shift relative to said housing.

10. A pressure plate assembly for a friction clutch as in claim 9 wherein the force exerting arrangement has an area which moves away from the housing upon the occurrence of wear and which can actuate the wear detection arrangement.

11. A pressure plate assembly as in claim 9 wherein said at least one blocking element comprises a wedge-like blocking slide which is pretensioned in an intermediate space between the housing and the wear-detection arrangement.

12. A pressure plate assembly as in claim 11 wherein said wear detection arrangement comprises a section that cooperates with the at least one adjusting element, said blocking arrangement being pretensioned between said housing and said section.

13. A pressure plate assembly as in claim 9 wherein said at least one adjusting element comprises an adjusting ring.

14. A pressure plate assembly as in claim 9 comprising a non-positive connection between said wear detection arrangement and said housing.

15. A friction clutch comprising a pressure plate assembly, said pressure plate assembly comprising:
a housing;
a pressure plate assembly connected to the housing for rotation in common about an axis of rotation;
a force exerting arrangement supported against the pressure plate and, via a path of support, against the housing;
a wear take-up arrangement in the path of support between the force exerting arrangement and the housing, the wear take-up arrangement comprising:
at least one adjusting element which shift by a take-up distance to compensate for wear and which supports the force exerting arrangement against the housing;
a wear detection arrangement carried on the housing and having a wear detection area which cooperates with said force exerting arrangement to shift said wear detection arrangement relative to said housing in the event of wear of said friction clutch, and further having a take-up distance limiting area which cooperates with said at least one adjusting element to limit the take-up distance; and
at least one blocking element which prevents the wear detection arrangement from reversing its movement after the shift relative to said housing.

16. A friction clutch as in claim 15 wherein said friction clutch is a dual clutch comprising two clutches, said wear take-up assembly being provided in one of the clutches.

17. A friction clutch as in claim 16 wherein a wear take-up assembly is provided in each of said clutches.
